(19) United States
(12) Patent Application Publication
(10) Pub. No.: US 2022/0347896 A1
(43) Pub. Date: Nov. 3, 2022

(54) FOAM BEAD, MOLDED ARTICLE FORMED OF A PLURALITY OF FOAM BEADS, AND METHOD FOR PRODUCING FOAM BEADS

(71) Applicant: Rouven SEITNER, Frankfurt (DE)

(72) Inventor: Rouven SEITNER, Frankfurt (DE)

(21) Appl. No.: 17/775,208

(22) PCT Filed: Nov. 3, 2020
(86) PCT No.: PCT/EP2020/080844

§ 371 Date: May 6, 2022

(30) Foreign Application Priority Data
Nov. 7, 2019 (EP) 19207585.1

(51) Int. Cl. B29C 44/34; B29C 44/50; B29C 48/04; B29C 48/21; B29C 48/345; F16L 59/02

(52) U.S. Cl. CPC B29C 44/3461; B29C 44/507; B29C 48/04; B29C 48/21; B29C 48/345; F16L 59/029; B29K 2067/003

(57) ABSTRACT

A foam bead intended in particular for the production of molded parts is also intended to be particularly suitable for novel, hitherto unknown applications, especially after processing into a corresponding molded part. For this purpose, the foam bead comprises, according to the invention, a core formed by a first plastic and a shell formed by a second plastic and at least partially surrounding the core, the second plastic forming the shell having a lower melting point than the first plastic forming the core.

### CROSS-REFERENCE TO RELATED APPLICATIONS

This application is a national phase entry of PCT/EP2020/080844, filed Nov. 3, 2020, and which claims priority to EP 19207585.1, filed Nov. 7, 2022, titled “FOAMED BEAD, MOLDING FORMED BY A PLURALITY OF FOAMED BEADS, AND METHOD FOR PRODUCING FOAMED BEADS,” each of which are hereby incorporated by reference in their entirety.

### FIELD OF INVENTION

The invention relates to foam beads, in particular for the production of moldings, and to a molding formed from a plurality of foam beads. It further relates to a process for producing such foam beads.

### BACKGROUND OF INVENTION

Foam beads or spheres of foamed plastic, also commonly referred to as “beads”, are used in a variety of applications, for example in the production of molded parts, where the molded parts are formed from a large number of such foam beads sintered or welded together. They provide a particularly good basis for a generally desired lightweight construction, since they have a comparatively high mechanical stability on the one hand and a very low density on the other—due to the high air content in the material as a result of foaming.

Such beads or foam beads are usually made of different polymers as base material. For example, EPS, EPP, EPE, copolymers and blends thereof are available as beads. Such foam beads are usually further processed in molding machines into molded parts, sheets or blocks that can be used in the insulation, automotive or packaging industries or in other technical applications.

Foam beads or beads made of EPS (expanded polystyrene) or EPP (expanded polypropylene) are currently particularly common. EPS beads (rigid foam) are usually offered on the market unfoamed as pre-gassed polystyrene and expanded by end processors, in particular so-called foaming companies, with the aid of steam into foam beads of various densities and then processed in the molding machines. In the EPP (flexible foam) sector, on the other hand, so-called mini pellets of polypropylene are already expanded at the raw material supplier to the density intended and suitable for later use, for example in an autoclave or by means of an extrusion process with direct gassing. The resulting foamed spheres or foam beads no longer contain any further blowing agent and can be processed directly by back pressure. For low densities, i.e. in the sense of a possibly targeted extreme lightweight construction, the beads can be reloaded with air pressure (pressure increase in the foam cells) and also re-expanded with steam.

The subsequent processing in the so-called molding process usually takes place in special molding machines. The actual processing step consists of softening the foam particles at least superficially by means of steam (steam temperature approx. 140 to 165° C.—depending on the type of raw material) so that they sinter or fuse. In contrast to PUR foam parts, subsequent processing (e.g. deburring) is not common for EPP molded parts.

In the multitude of possible applications of such molded parts formed from foam beads sintered or welded together, the focus is usually on individually different material properties that make their use particularly attractive. When used as an insulating material, for example in heating systems as sleeves for heating pipes or insulation of components, the flexible shaping in combination with—due to the high air content in the foamed beads—good thermal insulation properties is significant. When used as a molded part in the automotive industry, for example as a tiller element in car body parts, the focus is usually on low density in combination with comparatively high shock absorption, in line with the generally desired lightweight construction in combination with the likewise generally desired high passive safety. EPP foam, which is comparatively elastic, shock-resistant and particularly pleasant to the touch, offers a different range of applications.

The range of applications is essentially limited by the material properties of the plastic used for the foam beads themselves, since both the strength and dimensional stability of the molded part (via the strength and stability of the sintered or welded joint between the foam beads) and the thermal and mechanical properties of the volume body (via the volume or weight proportion of air content or plastic content in the foamed bead) are specified as target. The general aim here is to expand the number of possible applications even more than before and, in view of the large number of positive properties of such foam beads, to expand their possible uses even more than before.

### SUMMARY OF INVENTION

The invention is now based on the objective of specifying a foam bead of the above-mentioned type which, especially after processing into a corresponding molded part, is also suitable for novel, hitherto unknown applications. Furthermore, a molded part made of such foam beads as well as a process for the production of such foam beads are to be disclosed.

With regard to the foam bead, this task is solved according to the invention with the features of claim 1.

In particular, the foam bead has a core formed by a first plastic and a shell formed by a second plastic at least partially surrounding the core, the second plastic forming the shell having a lower melting point than the first plastic forming the core.

The invention is based on the consideration that the range of applications for moldings formed from sintered or welded foam beads is essentially characterized by two aspects of the foam beads: on the one hand, the volume properties of the respective foam beads, i.e. the material properties of the plastic used in combination with the air content, are decisive, for example, for the density (and thus ultimately the weight of the molded part), thermal conductivity of the molded part or the like. On the other hand, the surface properties of the foam bead determine the strength of the sinter or welded composite and thus the mechanical strength and load-bearing capacity of the molded part as a whole. Application possibilities and the usability of specific materials in general are limited, among other things, by the fact that in conventional construction, the plastic used must meet both the requirements for volume properties and the requirements for surface properties, i.e. the strength of the sintered bond or the usability in conventional process technology.

This is taken into account by a structure of the foam beads which permits a material-related or functional separation or decoupling of the volume on the one hand and the surface on the other. For this purpose, it is envisaged to provide a core for the foam bead, which is formative for the volume properties, but which is to be at least partially surrounded by a shell of another material in the manner of a hybrid or two-component design. This can be suitably selected with regard to the production and/or strength of the desired sintered connection between the beads without having to accept any restrictions on the choice of material for the core.

The melting point is regarded as a particularly important material property when selecting the materials for the core on the one hand and the cladding on the other, as this is significant for the cladding in particular with regard to the intended sintering process. The melting temperature is the temperature at which a material melts, i.e. passes from the solid to the liquid aggregate state. The melting temperature usually depends on the substance, but in contrast to the boiling temperature, it depends very little on the pressure (melting pressure). Melting temperature and pressure together are referred to as the melting point, whereby this describes the state of a pure substance and is part of the melting curve in the phase diagram of the substance.

The melting point of the second plastic forming the shell should be at least about 100° C., preferably at least about 120° C., lower than the melting point of the first plastic forming the core at an ambient pressure of about 1 to 5 bar, in particular in the steam atmosphere normally provided for further processing. Thus, due to the spread of the material parameters, reliable sintering or welding of the foam beads with each other is made possible, especially at process parameters common in plant processes, such as temperature and pressure (for example of the process steam used), even if the plastic characterizing the bulk or volume properties and used for the core would actually not be usable or processable at all under such conditions, for example due to a comparatively high melting point.

The first plastic forming the core is a polyester, particularly preferably based on polyethylene terephthalate (PET). PET is in fact eminently suitable for recycling processes, which is why recycled PET can also be used to manufacture a wide variety of products in addition to PET produced for the first time. Products made of PET play a major role in the market, and PET is preferred especially in the beverage and packaging industries, where lightweight bottles and packaging films are needed. In the case of recycling, PET bottles and PET films are shredded, and the resulting granules are used to make new bottles, sheets or films. However, the recycled material can also be used to produce other plastic parts, for example PET in the form of foamed sheets. Compared with similar foamable plastics from which molded parts can be made using beads, PET also has a better thermal insulation effect on the one hand and a significantly higher compressive strength in the foamed state compared with EPP or EPS, for example, so that the use of PET would be particularly attractive for the production of insulating bodies or the like. Overall, the use of PET as a base material in foam beads is thus already highly attractive in itself. A process for the production of a PET granulate is known, for example, from WO 2011/063806 A1.

However, PET has a melting point of 260° C. It is therefore not possible, or at least not commercially feasible, to use it in the usual plant technology for the production of molded parts from foam beads or beads, because in the currently usual plant technology in the area of molded part production (for example for EPP foam beads), temperatures in the range of 120° C. to 150° C. are predominantly used. Here, too, the beads are usually welded with the aid of steam; typical steam pressures are around 3.6 bar. Treatment of PET foam beads at such temperatures will cause expansion, but not welding. In fact, welding would require temperatures above 200° C., which would result in steam pressures of 20 bar and more.

Therefore, the use of PET beads or foam beads is not possible per se with regard to the currently common plant technology. The provision of foam beads with a core surrounded by a shell, as now envisaged in the invention, overcomes these problems and opens up the use of PET in foam beads even in common plant technology. The provision of PET alone as an additional option in the choice of material for the production of foam beads considerably expands the range of applications.

In combination with the choice of PET as the base material for the core, a plastic based on polypropylene (PP) is provided for the second plastic forming the shell. This ensures that the surface area relevant for the sintering or welding of the foam beads to one another is comparable in terms of its properties to that of conventional EPP beads or foam beads; the conventional and established plant technology used for processing EPP beads, including the common or preferred operating parameters, can therefore also be used without further ado for the hybrid or multicomponent foam beads now envisaged. PP has a melting point of about 160° C., whereas EPP has a melting point of about 140° C. so that the sintering or welding of the PP- or EPP-sheathed PET foam beads, which are provided in a very particularly preferred manner and are regarded as independently inventive, can take place at the temperatures of 120° C. to 150° C. that are normally provided and also largely implemented in terms of plant technology. The difference in melting points between the particularly preferred material pairings with PET for the core and PP or EPP for the jacket is thus about 100-125 K (for PET-PP) or 120-145 K (for PET-EPP).

Advantageous embodiments of the invention are the subject of the subclaims.

The jacket of the foam bead surrounding the core has the essential functional task of enabling the sintering or welding of the foam beads to each other under common plant conditions and process parameters, while ensuring sufficient dimensional stability and mechanical load-bearing capacity of the sintered body. For this purpose, it is conceivable and possible that the jacket does not completely enclose or cover the core; rather, it may be sufficient to provide the surface with a jacket only to the extent that, in any case, a sufficient material-side connection of adjacent foam beads to one another is ensured even in the case of a statistical positioning of a plurality of foam beads relative to one another. Advantageously, the jacket thus covers at least 70% of the surface of the core.

In a particularly advantageous embodiment, a dye additive is mixed into the plastic provided for forming the shell, i.e. the shell then exhibits a correspondingly predeterminable coloring. This makes quality control possible in a particularly simple manner by optical means, whereby, for example, with the aid of the colored identification it can be recognized how much of the surface of the core is covered by the cladding, whether the covering is continuous, and the like. This inspection can be carried out manually, i.e. by a human inspector, or also automatically or mechanically by using appropriately suitable detection systems. Particularly in the case of the latter, color coding in the color spectrum not visible to the human eye, for example in the ultraviolet, may also be provided; such additives are expressly intended to be included in the term “dye additive”.

Furthermore, in a particularly advantageous embodiment, also in view of the intended functional task of the jacket, which is to enable the foam beads to be bonded or welded to one another, the layer thickness of the jacket is suitably selected. In the selection of parameters for the design of the layer thickness of the jacket, it should particularly preferably be taken into account that it has a sufficient material thickness to enable an intensive and resilient material bond between adjacent foam beads, while on the other hand the volume contribution of the jacket should be kept sufficiently low so that the volume properties are dominated or determined unchanged by the material of the core. In a particularly advantageous embodiment, the cladding has a layer thickness of 0.1 to 0.5 mm.

In this particularly preferred embodiment, which is regarded as independently inventive, of a PET core provided with PP sheathing, in particular obtainable according to the process described below as a PET foam cylinder lin with PP sheathing, the foam beads provided in the manner of an intermediate product for subsequent further processing can be temporarily stored with recourse to already existing plant technology and, if necessary, loaded with ambient air under pressure. The foamed cylindrical granules can then or at a later stage be further processed using conventional EPP plant technology. In particular, the existing steam pressure and machine technology is sufficient to expand the PET foam and at the same time obtain a well-welded particle foam block due to the welding in the PP envelope ling.

With regard to the molded part, the aforementioned task is solved in that it is formed from a plurality of foam beads of the aforementioned type which are sintered or welded to one another on the surface. In particular, in a molded part according to the invention, a plurality of foamed plastic bodies formed from a first plastic is embedded in a matrix formed from a second plastic. Using the aforementioned foam beads in the manufacture of such a molded part, the bonding of the foam beads to one another is effected by welding the cladding layers to one another; the cladding layers thereby preferably form a matrix as a result, in which the original cores of the foam beads are embedded as separate plastic bodies.

Advantageously, in an embodiment analogous to the aforementioned embodiment of the foam beads, the second plastic forming the matrix has a lower melting point, preferably at an ambient pressure of about 1 bar a melting point at least about 100° C., particularly preferably at least about 120° C. lower than the first plastic forming the plastic bodies.

Particularly preferably and in an embodiment regarded as independently inventive, the foam beads and/or the molded part described above are used in/as insulating material for sanitary, heating or ventilation engineering (hot water pipe insulation, boilers, castings), insulating material for automotive engineering (sound and heat insulating parts such as engine compartment partitions, wheel housings), crash protection for automotive engineering (bumpers), and/or crash protection for protective equipment (helmets, knee pads).

With regard to the process for the production of foam beads of the type mentioned above, the said task is solved in accordance with the invention in that a melt of a first plastic, particularly preferably PET, is mixed with a blowing agent or blowing agent mixture and optionally additives and is prepared for subsequent extrusion, the extrusion taking place in a coextrusion, in which the foamed first plastic emerging from a perforated die expands and in the process is sheathed by a second plastic, particularly preferably PP, emerging from an annular die at least partially surrounding the perforated die, the resulting strand of the first plastic sheathed by a film of the second plastic being fed, after cooling, to a rotary die cutter and being separated there by the strand being squeezed together locally towards its center and then separated.

Thus, in coextrusion, in which foamed PET emerges from a central die and expands, a plastic film of polypropylene is applied in the form of a tube around the resulting strand of foamed PET and coats the PET strand. Due to the still comparatively high process temperature when the PET strand emerges from the die, the PP sheathing is firmly welded to the foamed PET strand, so that an intimate material bond is preferably formed between the foamed PET forming the core and the PP forming the sheathing. After cooling, the coextruded strands are advantageously fed to a rotary die cutter and separated there by squeezing the strand locally towards its center and then separating it or separating it into individual parts that form the foam beads. As a result of this separation process, the foam beads do not have an actual cylindrical shape but, due to the squeezing, have a tapered cross-section towards their ends, for example in the form of a conical shape. This in turn means that the end faces which are not covered or wetted by the shell can be kept comparatively small; the total achievable coverage of the core by the surrounding shell is thus particularly large. In particular, the area of the foam beads that is not wetted by the PP jacket can thus be significantly reduced, especially by 50-70%.

Advantageously, the second plastic used is one that has a lower melting point than the first plastic.

Alternatively, and in an embodiment regarded as independently inventive, the above-mentioned task is solved with regard to the process by mixing a melt of a first plastic, advantageously PET, with a blowing agent or blowing agent mixture and optionally additives, and then extruding and thereby expanding it, the resulting plastic foam strand being passed in a sheathing step through a treatment tank in which a second plastic, preferably polypropylene, is provided in liquid form.

Advantageously, the process parameters, in particular the process temperature, are again selected in such a way that when the foamed PET strand is passed through the PP bath, a PP coating is deposited on the surface of the PET strand and, due to the comparatively high temperatures, is firmly welded to it. Advantageously, the second plastic is provided in the treatment bath at a temperature of at least 140° C., particularly preferably at least 150° C. This ensures that, particularly in the case of the PP bath, a PP coating is deposited on the surface of the PET strand. This ensures that, particularly when a PP-based plastic is used as the second plastic, its melting temperature is safely exceeded.

Quite surprisingly, it has turned out that just with such operating parameters another significant advantage can be achieved: if the molten bath for coating the PET foam strands in the treatment tank is preferably kept at a temperature of about 150° C. in order to keep the PP as fluid as possible, the PET foam strands expand in all three spatial directions through contact with the PP as a result of its temperature. Thus, as a side effect of the wrapping step, so-called post-foaming is possible by temperature impact, whereby the air-gas mixture in the cells expands and the plasticized PET plastic yields to the pressure and expands further. This effect is possible in the present process because the PET has not yet become crystalline again directly after extrusion and expands again at temperatures from about 110° C. It is particularly advantageous that such a post-expansion in the melt bath continues to provide full encapsulation with PP melt, i.e. even during the post-expansion. Alternatively, if the bead were first coated with PP and then post-expanded in the oven, the bead would also expand, but the coating would break open and the PP skin would no longer fully cover the surface.

Particularly preferably, the melt bath or the treatment process is designed in such a way that the residence time of the PET strand in the treatment bath is about 10-30 seconds. As a result, the PET strand expands by approx. 40% and more. This design makes it possible to save a great deal of material when wrapping the strands and thus also to eliminate a further work step, such as post-expanding in an oven.

In a particularly preferred further development, the strand of foamed plastic is guided out of the treatment tank in a substantially vertical direction, so that any excess quantities still on the surface of the strand due to gravity run back into the treatment tank, where they are available for further coating.

In a still further alternative embodiment, which is also considered to be independently inventive, the above-mentioned task is solved with respect to the process in which a melt of a first plastic, advantageously PET, is mixed with a blowing agent or blowing agent mixture and optionally additives, wherein the polymer melt charged with the blowing agent is passed in a sheathing step through a flow channel in which a melt of a second plastic is provided and flows around the polymer melt charged with the blowing agent, wherein the sheathed melt thus formed is subsequently extruded and expanded. Here, too, the operating temperatures and other operating parameters can be advantageously selected in such a way that the post-expansion described above is made possible.

In a particularly advantageous embodiment, the second plastic is provided with a color additive. Preferably, this is used for quality control, in that the first plastic coated with the second plastic is subjected to an optical quality control, whereby a code number for the proportion of the coating of the first plastic by the second plastic is determined by means of the color additive.

The advantages achieved with the invention consist in particular in the fact that the two-component design of the foam bead enables functional separation between the core on the one hand and the shell forming the surface on the other, so that the core can be specifically adapted to the volume-related requirements with regard to its design, for example material selection, air content and the like. Independently of this, the shell can be specifically adapted to the surface-specific requirements, in particular good sintering behavior and/or high strength after sintering or welding of the foam beads, without having to accept disadvantages in the volume range. In particular, the design according to the invention allows the inclusion of new materials, very preferably PET, while retaining the established and already existing plant technology for further processing.

In particular, in the embodiment of a PP-sheathed PET foam bead considered to be independently inventive, in which the core is made of PET and the sheath is made of PP, the following advantages, among others, are achieved:

The foam beads (for example, in the mentioned cylindrical shape) can also be produced in relatively high densities in the range of 100-300 kg/m³, depending on the requirements.

If required, the PET foam core can be pre-expanded in a pre-foaming process at temperatures around 120° C. without the PP jacket causing the foam beads to weld together.

The foam beads or beads can be temporarily stored like conventional EPS or EPP foam beads, using existing plant technology and operating parameters, and loaded with compressed air if necessary.

The foam beads or beads can be fed to conventional EPP molding equipment and foamed and/or welded with steam in the common temperature range of approximately 150° C.

The EPP foam industry would be able to process E-PET with existing technology and open up new areas of application.

### BRIEF DESCRIPTION OF THE DRAWINGS

An embodiment of the invention is explained in more detail with reference to a drawing. Therein show:

FIG. 1 a foam bead in section,

FIG. 2 a molded part composed of a plurality of foam beads according to FIG. 1,

FIG. 3 schematic longitudinal section of a coextrusion die provided for the production of foam beads according to FIG. 1.

FIGS. 4,5 each a schematic of a system for producing foam beads according to FIG. 1,

FIG. 6 schematic of a separation station,

FIG. 7 some variants of foam beads in longitudinal section, and

FIG. 8 also shows some variants of foam beads in longitudinal section.

Identical parts are marked with the same reference signs in both figures.

### DETAILED DESCRIPTION OF THE DRAWINGS

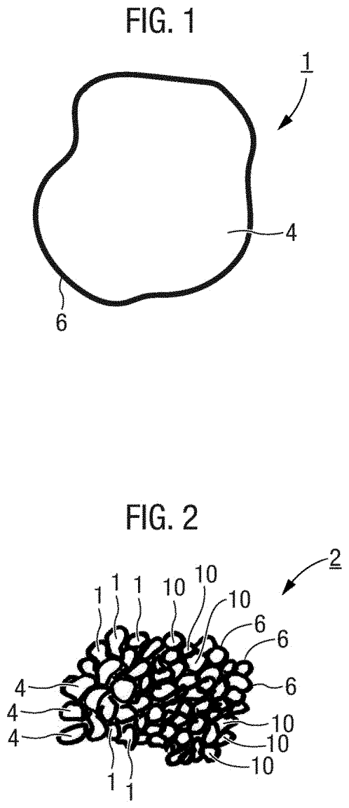

The foam bead 1 according to FIG. 1, also referred to as a ball of foamed plastic or also as a “bead”, is suitable and intended for a variety of applications, for example for the production of a molded part 2, as shown in FIG. 2. To produce the molded part 2 from a plurality of such foam beads 1, they are sintered or welded together.

The foam bead 1 is specifically designed for an extended range of applications in which—if possible with recourse to existing plant and process technologies—novel materials, which for various reasons could not previously be used for these purposes, are also to be made accessible for possible use. In order to make this possible, the foam bead 1 is designed in the manner of a hybrid design with two or more components; it comprises a core 4 formed by a first plastic and, in addition to this, a jacket 6 formed by a second plastic and at least partially surrounding the core 4. This two- or multi-component design means that the core 4 can be designed independently of the jacket 6 in terms of material selection and other properties. This is used in the present case to also be able to use PET as a base material for the provision of foam beads 1.

In the embodiment example, the core 4 of the foam bead 1 is thus made of a polyester, namely PET. This means that the numerous advantages and favorable properties, in particular the possible integration into the recycling chain, can also be utilized for foam parts. However. PET has a melting point of around 260° C., so that further processing by sintering or welding to produce a molded part 2 would not be possible using conventional plant technology. In fact, conventional molding plants usually operate at working temperatures of about 120° C. to 150° C.; this would not be sufficient to bring about the sintering of the PET foam beads necessary for the production of a molded part 2 from PET beads.

To remedy this situation, the PET core 4 in foam bead 1 is surrounded by the jacket 6 made of the second plastic. The material is selected in such a way that the second plastic forming the jacket 6 has a significantly lower melting point than the first plastic forming the core 4. In the embodiment example, polypropylene (PP) is provided as the material for the sheath 6; the foam bead 1 is thus a PP-sheathed PET bead. Polypropylene has a melting point of about 160° C. and thus a significantly lower melting point than PET. The two-component structure of foam bead 1 thus ensures that the volume properties (for example elasticity, thermal conductivity, etc.) are imprinted by the material forming the core 4, i.e. PET,—whereas the surface properties relevant for the sintering or welding of the foam beads to one another are imprinted by the PP forming the shell 6. The foam bead 1 is thus a foam bead 1 that essentially consists of PET, but can be treated during further processing and sintering in framework conditions and corresponding plant technology, as is available and already established for EPP beads.

The molded part 2 obtained by sintering or welding a plurality of foam beads 1 is shown in FIG. 2. The predominantly interlocking connection of adjacent foam beads 1 to one another is achieved via the respective shell 6, with the cores 4 remaining intact. After its manufacture, the molded part 2 thus adopts the matrix structure shown in section in FIG. 2, in which a plurality of foamed plastic bodies 10 corresponding to the original cores 4 and formed from the first plastic, namely PET in this case, are embedded in a matrix 12 formed from the second plastic, namely PP in this case. The matrix 12 is created by the sealing process. The matrix 12 is thereby formed by fusing, sintering or welding the jackets 6 of the foam beads 1 to one another.

The production of foam beads 1 of the embodiment shown is possible in several ways, of which only two, each considered independently inventive, are explained in more detail by way of example below. The two exemplary embodiments listed have in common that they are based on the extrusion of continuous strands with subsequent separation, for example by cold cutting, in a departure from the water granulation processes actually commonly used in the production of foam beads or beads. The following embodiments are explained by way of example on the basis of the particularly preferred material pairing of PET as the first plastic for forming the cores 4 and polypropylene (PP) as the second plastic for forming the cladding 6, which is considered to be independently inventive; of course, other material pairings are also conceivable and covered by the present invention, depending on the requirements which may be specified specifically for the application.

In a first embodiment for the production of foam beads 1, a PET melt is first mixed with a blowing agent or blowing agent mixture and, if necessary, additives and then fed to a coextrusion. In particular, the extrusion of foam strands from the PET melt in the density range 100-200 kg/m³ can first be carried out for this purpose by means of known extrusion technology, for example in the manner of an extrusion first via a twin-screw melting screw with gas flushing and then a downstream single-screw unit for homogenization.

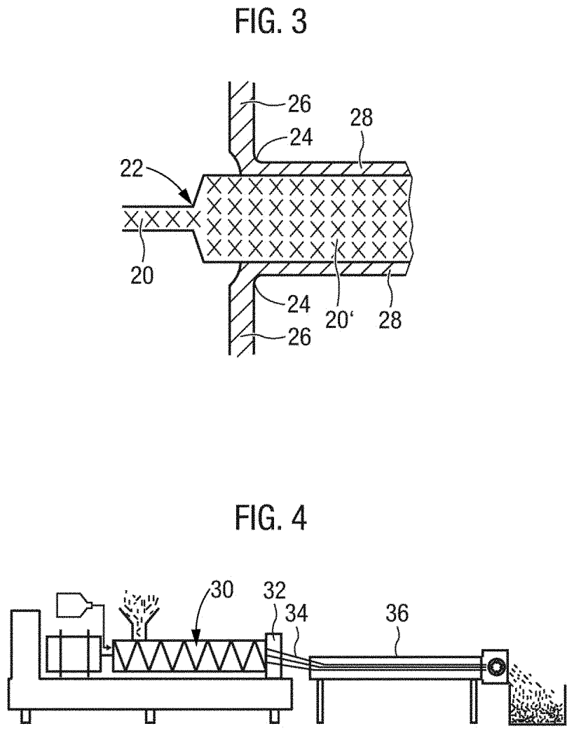

Subsequently, as shown schematically in FIG. 3, this pre-extruded PET foam strand 20 is then fed into a co-extrusion line driven by a co-extruder. A perforated nozzle 22 surrounded by an annular nozzle 24 is provided. A material flow 26 of polypropylene (PP) is applied to the annular nozzle 24. As soon as the PET foam strand 20 emerges from the perforated nozzle 22, it expands to approximately twice the diameter of the perforated nozzle 22. The PET foam strand 20′ expanded in this way is then coated with a PP film 28 emerging from the perforated nozzle 24 in the form of a tube during coextrusion.

Immediately after its exit from the perforated nozzle 20, the expanded PET foam strand 20′ still has a comparatively high process temperature. As a result, the PP film 28 is firmly welded to the foamed PET strand 20′ during wrapping. This creates an intimate material bond between the foamed PET forming the core 4 and the PP forming the jacket 6.

After subsequent cooling, for example in a water bath, the coextruded strands, i.e. the PP-sheathed PET foam strands, are separated by means of a rotary die cutter by locally squeezing the sheathed strand towards its center and then separating it. This results in individual bodies that deviate from an actual cylindrical shape and have pointed or tapered end areas with comparatively small end faces. These individual bodies then form the actual foam beads 1, in which a PP jacket 6 surrounds the foamed PET core 4.

The concept of an alternative process for the production of foam beads 1 is shown schematically in FIGS. 4 and 5 on the basis of the plant provided for the production in two embodiments. In these embodiments, which are considered to be independently inventive, a PET melt is also first mixed with a blowing agent or blowing agent mixture and optionally additives. The resulting mixture 30 is then extruded in a die 32 and expanded in the process. The resulting PET foam strand 34 is subsequently passed through a treatment basin 36 in a sheathing step. In the treatment basin 36, polypropylene (PP) is provided as the second plastic. The treatment tank 36 is heated and suitably tempered by means of a heating device not shown in more detail, so that the PP in the treatment tank 36 is in the liquid state.

The process parameters, in particular the process temperature, are selected in such a way that a PP coating 38 is deposited on the surface of the PET foam strand 34 when the PET foam strand 34 is passed through the PP bath. Due to the comparatively high temperatures of the PET foam strand 34 in this phase, the sheathing 38 is firmly welded to the PET foam strand 34 during deposition. In the particularly preferred embodiment, the second plastic is thereby provided in the treatment tank 36 at a temperature of at least 140° C., particularly preferably at least 150° C. This ensures that when a PP bath is used for the second plastic, its melting temperature is safely exceeded.

Since the molten bath provided in the treatment tank 36 for coating the PET foam strands 34 is kept at a temperature of about 150° C. in order to keep the PP as fluid as possible, the PET foam strands 34 expand in all three spatial directions through contact with the PP as a result of its temperature. Thus, as a side effect of the wrapping step, so-called post-foaming is possible by temperature impact, whereby the air-gas mixture in the cells expands and the plasticized PET plastic yields to the pressure and expands further. This effect is possible in the present process because the PET has not yet become crystalline again directly after extrusion and expands again at temperatures from about 110° C.

It is particularly advantageous that this type of post-expansion in the melt bath ensures that the bead continues to be fully encased in PP melt, i.e. even during post-expansion. Alternatively, if the bead were first coated with PP and then post-expanded in the oven, the bead would also expand, but the coating would break open and the PP skin would no longer fully cover the surface.

Subsequently, the PET foam strand 34 provided with the jacket 38 is passed through a water bath 40 for cooling and then separated in a separating station 42 in the manner of a cold cut and cut into cylinders or also separated by squeezing in a rotary die cutter as described above. The individual parts obtained in this way then form the actual foam beads 1, in which a PP jacket 6 surrounds the foamed PET core 4.

As can be clearly seen from the illustration in FIG. 5, in this embodiment the PET foam strand 34 provided with the jacket 38 is directed out of the treatment tank 36 in a substantially vertical direction indicated by the arrow 44. This aspect is particularly preferred and is considered to be independently inventive, because this orientation causes excess residual amounts of the jacket material (PP) still on the surface of the foam strand 34 to be automatically conveyed by gravity back into the treatment basin 36, where they are available for further coating.

In this variant, or optionally also in the variant described above, it is intended to mix a dye additive into the plastic provided for forming the shell 6, so that the shell 6 has a correspondingly predeterminable coloring. This makes subsequent quality control possible in a particularly simple manner by optical means, whereby, for example, with the aid of the colored identification it can be recognized how much of the surface of the core 4 is covered by the jacket 6, whether the covering is continuous and the like. In the embodiment example according to FIG. 5, this check is automated, with a corresponding detection system 50 being provided in the area of the separating station 42. In the embodiment example, color coding is provided in the color spectrum not visible to the human eye, for example in the ultraviolet by means of a UV tracer.

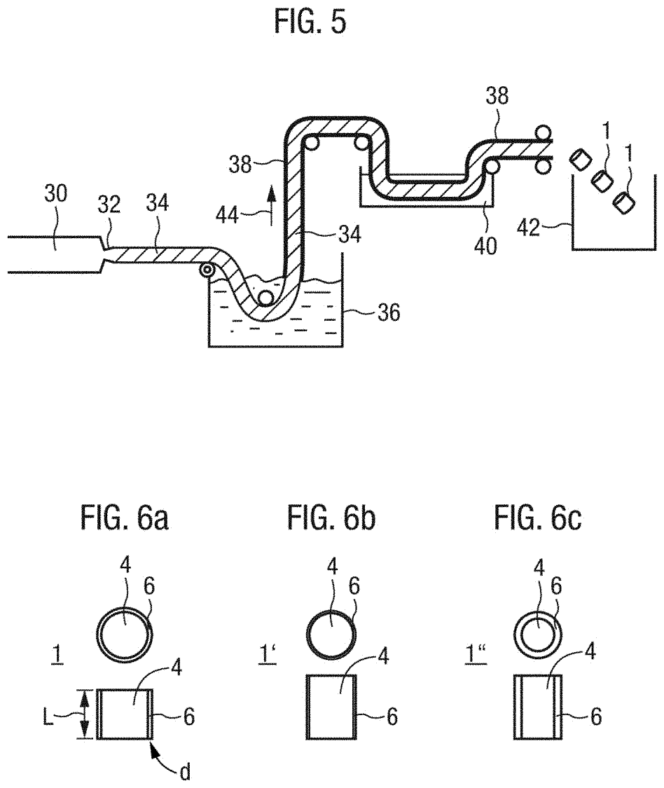

As mentioned above, the separating station 42 could, for example, be designed in the manner of a conventional cold cut. This results in foam beads 1 with an essentially cylindrical basic shape. With regard to the respective intended application, the geometry parameters for the core 4 and the shell 6 in particular are advantageously selected to be suitable in each case. Some particularly preferred examples of embodiments for the jacketed PET foam beads in cylindrical form produced by one of the aforementioned processes and forming the foam beads 1 are shown in FIG. 6, in each case both in transverse and in longitudinal section. The foam bead 1 shown in FIG. 6a has a length L of 3.0 mm and a core diameter of 3.0 mm; the shell thickness d is 0.25 mm. In contrast, foam bead 1′ according to FIG. 6b has a length L of 4.0 mm, a core diameter of 3.0 mm and a shell thickness d of 0.1 mm, and foam bead 1″ according to FIG. 6c has a length L of 4.0 mm, a core diameter of 2.0 mm and a shell thickness d of 0.5 mm. The geometry parameters of these particularly preferred embodiments are summarized in the following table:

| | Foam bead 1 | | Foam bead 1′ | | Foam bead 1″ | |
|---|---|---|---|---|---|---|
| Core diameter | 3.0 | mm | 3.0 | mm | 2.0 | mm |
| Length | 3.0 | mm | 4.0 | mm | 4.0 | mm |
| Total surface core | 42.4 | mm² | 51.8 | mm² | 31.4 | mm² |
| Overlap: Proportion of | 66.7% | | 72.7% | | 80.0% | |
| shell surface | | | | | | |
| Sheath thickness | 0.25 | mm | 0.1 | mm | 0.5 | mmm |
| Mass core | 2.1 | mg | 2.8 | mg | 1.3 | mg |
| Mantle mass | 0.7 | mg | 0.4 | mg | 1.3 | mg |

| | | | |
|---|---|---|---|
| Mass ratio shell/core | 33.3% | 13.3% | 100% |

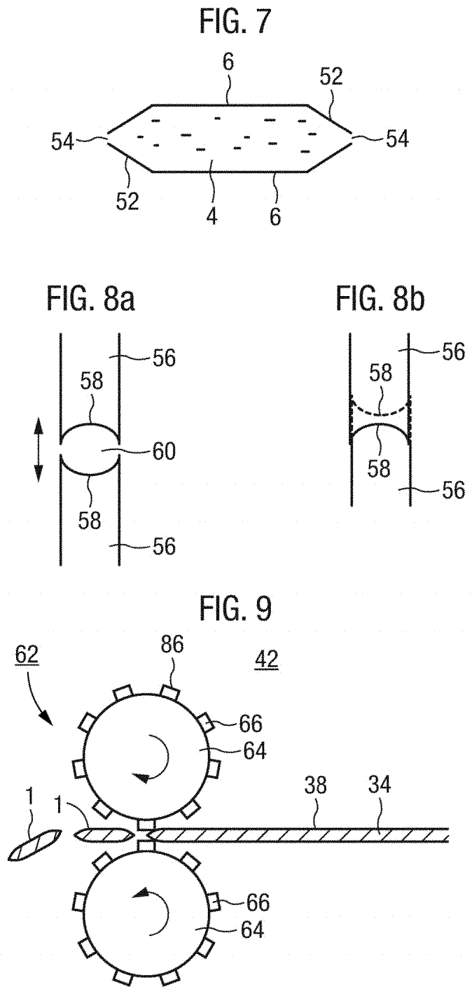

In an embodiment regarded as independently inventive, however, instead of the cylindrical body shape, a body shape tapering at the ends is provided as the basic shape for the foam bead 1. Such a foam bead 1′″ shown in longitudinal section in FIG. 7 has, in deviation from an actual cylindrical shape, pointed or conically tapering end regions 52 with comparatively small end faces 54. This ensures that the exposed surface parts of the foamed PET core 4 not surrounded by the PP sheathing 6 can be kept particularly small. This is particularly favorable for the sintering process envisaged later, since the portion available for this purpose formed by the jacket 6 is then particularly large.

Such a body shape could be produced in the separating station 42, for example, by suitably shaped and contoured cutting knives 56, as shown schematically in FIG. 8. The cutting knives 56 each have a concave cutting edge 58. In the open position of the cutting knives 56 (FIG. 8a), the sheathed strand 34 can then be introduced into the opening 60 between the cutting edges 58. When the desired length is cut, the cutting blades 56 are then moved toward each other so that the opening 60 closes (FIG. 8b). In the process, the strand 34 is squeezed at the desired location and finally separated, creating the desired body shape due to the material deformation.

Quite preferably and in an embodiment regarded as independently inventive, however, the separating station 42, in particular for producing the body shape mentioned, is designed in the manner of a rotary die cutter 62, which is assumed to be known per se, as shown in sketch form in FIG. 9 on the basis of its essential components. In the embodiment example, the rotary die cutter 62 comprises two rotary elements 64 arranged at a distance from one another, which in the embodiment example are preferably designed as rotary rollers. A number of punching elements, in particular punching grooves 66, are arranged on their outer cylinder surface. In particular, the rotary rolls 64 can be operated synchronized with one another in such a way that in each case a punching groove 66 of a first rotary roll 64 assumes its reversal point in the gap formed by the roll spacing at the same time as an associated punching groove 66 of the second rotary roll 64, so that when the rolls 64 rotate, the clear width of this gap assumes a minimum value.

The PET foam strand 34 provided with the sheathing 38 is passed through this gap, where it is squeezed locally towards its center by the punching grooves 66, which cooperate in pairs, and thus separated. As a result of the shape of the punching grooves and the arrangement, individual bodies with the desired body shape are produced. These individual bodies, as shown in enlarged form in FIG. 7, then form the actual foam beads 1″″, in which the PP jacket 6 surrounds the foamed PET core 4.

The PET foam cylinders with PP coating 38, which form the foam beads 1 and are produced by one of the two processes described above—or by another process—can then be stored temporarily and, if necessary, loaded with ambient air under pressure, depending on the requirements of the application. The foamed cylindrical granules can then later be further processed using normal, conventional EPP plant technology. In particular, the steam pressure and machine technology is sufficient to expand the PET foam material and, at the same time, to obtain a well-welded particle foam block or a well-welded molded part 2 due to the welding in the PP sheathing 38.

The design of foam bead 1 as a PP-sheathed PET bead allows, among other things, the following scope for subsequent application, thus expanding the range of applications overall:

The foamed cylindrical raw material can also be produced in relatively high densities in the range of 100-200 kg/m³, depending on requirements.

If necessary, the PET foam core 4 can be pre-expanded using a pre-expansion process at temperatures of about 120° C. without the PP jacket 38 causing welding of the foam beads 1.

The foam beads 1 can be temporarily stored like conventional EPS or EPP beads and, if necessary, loaded with compressed air.

The foam beads 1 can be fed to conventional EPP molding equipment and processed there, in particular foamed and welded with steam in the temperature range of about 150° C.

Overall, the EPP foam industry will be able to process E-PET with existing technology and open up new areas of application.

### LIST OF REFERENCE SIGNS

1 Foam bead
2 Mold part
4 Core
6 Coat
10 Plastic body
12 Matrix
20,20′ Foam strand
22 Hole nozzle
24 Ring nozzle
26 Material flow
28 Slide
30 Mixture
32 Nozzle
34 Foam strand
36 Treatment basin
38 Sheathing
40 Water bath
42 Single station
44 Arrow
50 Recognition station
52 End range
54 Face
56 Cutting knife
58 Cutting edge
60 Opening
62 Rotary punch
64 Rotation elements
66 Punching grooves
L Length
D diameter
d Sheath thickness

1. A foam bead having a core formed by a first plastic based on polyethylene terephthalate (PET) and having a shell which at least partially surrounds the core and is formed by a second plastic based on polypropylene (PP), the second plastic forming the shell having a melting point at an ambient pressure of about 1 to 5 bar, in particular in a steam atmosphere, which is at least about 100° C. lower than that of the first plastic forming the core.

2. The foam bead of claim 1, in which the second plastic forming the shell is provided with a color additive.

3. The foam bead of claim 1, in which the shell covers at least 65% of the surface of the core.

4. The foam bead of claim 1, in which the shell has a layer thickness of about 0.1 to 0.5 mm.

5. A molded part, in particular for use in/as insulating material for sanitary, heating or ventilation technology (hot water pipe insulation, boilers, castings), insulating material for automotive engineering (sound and heat insulating parts such as e.g.—engine compartment partitions, wheel housings), crash protection for automotive engineering, (bumpers), and/or crash protection for protective equipment (helmets, knee pads), formed from a plurality of the foam beads of claim 1, sintered or welded together on a surface.

6. A method for producing the foam beads of claim 1, in which a melt of the first plastic is mixed with a blowing agent or blowing agent mixture and, if appropriate, additives and is made ready for subsequent extrusion, the extrusion being carried out in a coextrusion in which the foamed first plastic emerging from a perforated nozzle expands and, in the process, is encased by a second plastic emerging from an annular nozzle at least partially surrounding the perforated nozzle, characterized in that the resulting strand of the first plastic, which is sheathed by a film of the second plastic, is fed to a rotary die cutter after cooling and is separated there by squeezing the strand locally towards its center and then separating it.

7. A method for production of the foam beads of claim 1, in which a melt of the first plastic is mixed with a blowing agent or blowing agent mixture and, if appropriate, additives and is then extruded and expanded in the process, characterized in that the resulting plastic foam strand is passed in a sheathing step through a treatment tank in which the second plastic is provided in liquid form.

8. The method of claim 7, wherein the second plastic is provided in the treatment tank at a temperature of at least 140° C.

9. A method for production of the foam beads of claim 1, in which a melt of the first plastic is mixed with a blowing agent or blowing agent mixture and, if appropriate, additives, characterized in that the polymer melt loaded with the blowing agent is passed in a sheathing step through a flow channel in which a melt of the second plastic is provided and flows around the polymer melt loaded with the blowing agent, the sheathed melt formed in the process subsequently being extruded and—expanded in the process.

10. The method of claim 7, in which a resulting strand of the first plastic, sheathed by a film of the second plastic, is fed, after cooling, to a rotary die cutter and is separated there by squeezing the strand locally towards its center and subsequently separating it.

11. The method of claim 6, in which the second plastic is provided with a color additive.

12. The method of claim 1, in which the first plastic coated with the second plastic is subjected to optical quality control, a characteristic number for a proportion of the coating of the first plastic by the second plastic being determined by means of the color additive.
